(19) United States
(12) Patent Application Publication
(10) Pub. No.: US 2005/0061726 A1
(43) Pub. Date: Mar. 24, 2005

(54) Filtering apparatus of filter press type with filter carriage(s) accommodating filter module(s) comprising filter elements

(75) Inventors: Gerhard Strohm, Dexheim (DE); Georg Schnieder, Bad Kreuznach (DE)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY (US)

(21) Appl. No.: 10/953,075

(22) Filed: Sep. 30, 2004

Related U.S. Application Data
(63) Continuation of application No. PCT/EP03/03743, filed on Apr. 10, 2003.

(30) Foreign Application Priority Data
Apr. 10, 2002 (DE) 102 16 305.7

(51) Int. Cl. B01D 25/127

(52) U.S. Cl. 210/227; 210/224; 210/228; 210/330

(57) ABSTRACT

A filtering apparatus is described which is designed to reduce or completely eliminate dripping losses and in which fitting or exchanging filtering elements can be carried out in a simpler manner. The filtering apparatus is characterized in that there is provided, between the end plate and the pressure plate, at least one filter carriage mounted for displacement on the cross beams and having a compression-proof outer wall and exhibiting at least one chamber for the accommodation of at least one filter module composed of filtering elements.

This application is a continuation application of pending international application No. PCT/EP03/03743, filed Apr. 10, 2003, which is incorporated herein by reference in its entirety and for all purposes.

### BACKGROUND OF THE INVENTION

The invention relates to a filtering apparatus, especially a filter press, having a support extending along a lengthwise direction of the filtering apparatus, a pressuring device comprising a stationary head mounted at one end of said support and a movable head which is movably supported on said support and spaced apart from said stationary head. The movable head and/or the stationary head comprise connector elements for feed and filtrate. In the space being provided between the movable head and the stationary head filtering elements are accommodated. The invention also relates to a filter carriage and to a supplementary set or retrofit kit for filtering apparatus.

Such filtering apparatus are also known as filter presses because the filtering elements are pressed against each other by means of the pressing device prior to filtration. A horizontal filter press 1′ of the prior art is illustrated diagrammatically in FIG. 1.

On a rack provided with a pillar 8 there is disposed a displaceable movable head or pressure plate 2 and a stationary head or end plate 4, between which filter plates 5 and filter frames 6 are provided in an alternating sequence. Filtering elements, particularly layers of filtering material, are clamped between the filter plates 5 and the filter frames 6. The filter plates 5 and filter frames 6 are displaceably mounted on two cross beams 3 disposed between the pressure plate 2 and the end plate 4 so that they can be pressed together by means of the pressing device, which in the embodiment shown here comprises a spindle 9 and a handwheel 10. Between the stack comprising filter plates and filter frames and the respective end plate or the pressure plate there is provided an adapter in the form of plate 7, which adapter plate forms a link to the filtrate and feed (or non-filtrate) connector elements in or on the end plate 4 or pressure plate 2 respectively.

These filter presses are used for clarifying, degerminating, or declouding filtration of liquids and are used, for example, in the chemical and pharmaceutical industries and the beverage industry.

The advantages of these sheet filter presses consist in that the construction of the racks is simple, that the filtering apparatus can be arbitrarily enlarged or diminished in size by changing the number of filter plates so as to afford easy adaptation to the particular filtration task, that the filtering device can be readily degassed and emptied, and that the filter plates are readily accessible for changing the filtering elements.

This is offset by a number of drawbacks, however. For example, the filtering elements also serve as a seal between the filter plates and filter frames so that by-passes are inevitable on account of the porosity of the filtering materials. The undesirable leakage of feed or filtrate is referred to in the art as dripping losses. In addition, the fluid can be impaired by materials that diffuse in or diffuse out. In the case of filtration of fluids containing toxic ingredients there is the risk of these passing into the environment via the by-passes.

Various attempts have hitherto been made to provide a remedy for this. DE 35 20 171 A1 discloses a device of the type, in which the filter stack formed by a horizontal row of in-line filtering elements including its support means is surrounded by a protective covering. This protective covering prevents material leaking from the filter stack during filtration from disturbing the operator(s) or contaminating the filter stack. The protective covering can be completely removed, at least from the region of the filtering elements of the filter stack, when the filter press is opened, particularly for work on the filtering elements, for unhindered exchange of the filtering elements, and for the removal of filter cakes to be recovered or discarded. The drawback of this device consists in that considerable space is necessary and that this device is not capable of being retrofitted.

WO 99/17861 discloses a filter press in which a special layer of wax is provided between the layers of filtering material to provide a seal and to avoid dripping losses.

Elaborate sealing means are disclosed in DE 39 068 16 C3.

### SUMMARY OF THE INVENTION

It is an object of the present invention to reduce or entirely avoid dripping losses in a filtering device and to simplify equipping the filtering device and exchanging the filtering elements. In particular, existing filtering devices can be retrofitted due to the improvements afforded by the invention so that the existing racks and pressing devices and the movable heads (pressure plates) and stationary heads (end plates) and their associated connections can still be used in unchanged form.

This object is achieved with a filtering device defined in claim 1.

The provision of the invention is that between the end plate (stationary head) and the pressure plate (movable head) there is provided at least one filter carriage which is displaceably mounted on the support and has a compression-proof outside wall and which exhibits at least one chamber for accommodation of at least one filter module composed of filtering elements.

Preferably the support comprises two cross beams.

Any arrangement of filtering elements is regarded as a filter module in which the filtering elements are integrated to form a stack which can be handled as a unit and the non-filtrate should impinge on the filter module from the outside, and the interior of the module should exhibit at least one filtrate interceptor. Exemplary filter modules which can be used in connection with the filtering device of the invention, are described, for example, in DE 198 372 57 A1, DE 197 058 56 A1, and DE 197 058 55 A1. In the case of these known filter modules, it suffices when the individual filtering elements are locked together for transportation purposes only but can otherwise be interconnected so as to be displaceable in the longitudinal direction with respect to each other so that the filter module can be compressed when in the filtering device. Alternatively, precompressed modules can be used, such as are described in DE 100 299 60 A1.

Although the device of the present invention basically may comprise only one filter carriage having one chamber and one filter module, the filtering device will preferably be equipped with a number of filter carriages, each having a number of chambers accommodating a number of filter modules. The embodiments of the filter carriage that are preferred will be described below.

Instead of the filter plates and filter frames conventionally provided, the filter carriages are mounted on the support, e.g., cross beams designed to accept the filter carriages for displacement thereon. Equipping of the filtering device is carried out by releasing the pressing device and moving the filter carriages away from each other so that the chamber(s) of the carriages become accessible and can be filled with the prepared filter modules. Once the filter carriage has been equipped with the filter modules these are merely moved together and the pressing device applies the pressure necessary to press the filter modules with their filtrate interceptors against the corresponding filtrate orifices in the corresponding feed and filtrate means. Simultaneously, the filter carriages are pressed against each other, seals being preferably provided between the filter carriages to prevent fluid from escaping. Within the filter carriages, i.e., their chambers, pressure filtration is carried out, and the resulting filtrate is removed through the filtrate interceptors of the filter modules via the filtrate outlets present in the adapter or the end plate or the pressure plate.

Existing filtering devices can be retrofitted by the filter carriages of the invention. Retrofitting can be carried out cheaply because no modification of the existing connections is necessary. Retrofitting can be carried out without loss of time because only the filter plates and filter frames have to be replaced by the filter carriages. Furthermore, the user can return to the old system at any time.

Due to the fact that a closed system is made available, there are no losses of product and there is no contamination of the environment, and gasses cannot diffuse into the filtering device from the environment.

Furthermore, only a few gaskets are necessary because gaskets are only required, if at all, between the filter carriages and between the filter carriages and the adapter or the end plate or pressure plate. The chambers of the filter carriages are easier to clean and sterilize and the exchange of filter modules takes place faster than an exchange of individual filter plates or filtering elements present in the filter plates, particularly when these are layers of filtering material. Following filtration the filter modules are disposed of as complete units so that very little effort is required to equip the filtering device with fresh filter modules. There is distinct overall improvement in filtration and handling.

In order to accelerate changing of the filter modules even more, a lifting device can be additionally provided, by means of which the filter carriages can be lifted out from the space between the pressure plate and the end plate so that the faces of the first and last filter carriages become open to access. When retrofitting is carried out, fresh filter modules are pushed into the chambers with the result that the spent filter modules are simultaneously knocked out at the opposite end. Thus very little effort is necessary to effect retrofitting. The filter carriages are then lowered by means of the lifting device and come to rest on the cross beams of the filtering device.

Preferably, the longitudinal axis of the chambers runs parallel to the support (e.g., cross beams). This has the advantage that when a number of filter carriages are disposed in line the filter modules disposed in the chambers are also in line and thus the number of filter carriages and filter modules in the filtering device is freely selectable.

The filter carriages are preferably open at one or both ends so that the filter modules can be introduced into the filter carriage. When the filter carriage is open at one end only, it possesses, at the opposite end, an end wall having filtrate orifices and feed orifices to match the filter module. These end walls can be releasably connected to the filter carriage (e.g., by screws or pins) or they can be welded thereto. This embodiment is of advantage when a large number of filter carriages are disposed successively in a row and there is the risk that the row comprising a large number of filter modules might sag following compression, as a result of which leakage might occur, particularly in the region of adjacent filtrate channels of the filter modules. The use of filter carriages which are closed at one end provides a greater-degree of overall stability as regards positioning of the filter modules.

Preferably, the filter carriage is rectangular in cross-section. The filter chamber(s) may thus also be rectangular in shape so that filter modules that are rectangular in cross-section can be used.

Since the feed (or non-filtrate) is forced into the filter chamber, during filtration, at a pressure of up to 10 bar, the outer wall of the filter carriage must be capable of withstanding this pressure. Depending on the size of the filter carriage and the chambers disposed in the filter carriage, it may be necessary to provide at least one horizontal and/or vertical tension strut. The said strut or struts are preferably arranged such that they delimit said chamber or chambers. These struts can be in the form of a stiffening cross or as partitions containing passages for the feed. The struts can be formed in such a manner that they delimit the chambers leak-sealingly or non-leak-sealingly.

To guarantee unproblematic retrofitting of existing filtering devices, which are generally available in three standard sizes, it is an advantage when the filter carriage has one, four, or nine chambers, whose cross-sections conform to specific modular dimensions. The chambers are preferably arranged in juxtaposed and superposed relationship within the filter carriage. In this case the carriages are preferably square in cross-section and have edge lengths of 400 mm, 600 mm, and 1000 mm. These exterior dimensions permit an arrangement of chambers having interior dimensions of ca 280 mm so that one and the same type of module can be used in all three sizes of filter carriage without further modification.

Advantageously, the carriage has along its longitudinal axis at least two chambers disposed in line and separated from each other by a vertical partition having filtrate orifices and feed orifices. It is thus possible to make relatively long carriages so that a few carriages will suffice for one filtering device. The number of points to be sealed is thus considerably reduced.

To ensure that the filter modules can be compressed when the pressing device is actuated, the length L₁ of the chamber is less than L₂, L₂ being the length of the filter module to be placed in the chamber.

According to another advantageous embodiment, intermediate plates of similar cross-section are disposed between two filter carriages, said plates having filtrate orifices and feed orifices. These intermediate plates have the same function as the end walls of the filter carriage open at one end. The interposition of intermediate plates serves to increase the stability of the filter module configuration.

These intermediate plates are preferably also slidably mounted on the cross beams so that the intermediate plates cannot fall down when the filter carriages are moved away from each other.

Between the pressure plate and the adjacent filter carriage and/or between the end plate and the adjacent filter carriage there is preferably provided an adapter having means for feeding in the feed and means for removing the filtrate.

The adapter preferably comprises a perforated plate adjacent the filter carriage and an adapter frame disposed between the perforated plate and the end plate or pressure plate. The perforated plate can be releasably attached to the adapter frame, e.g., by means of screws or a pin-and-socket connection, or it can alternatively be welded. The adapter serves for adaptation to the existing connections on the pressure plate or end plate and the filter modules used.

The perforated plate preferably has filtrate and feed orifices or openings.

The adapter frame connects the connections for filtrate and feed in the pressure plate and/or end plate to the filter module or filter modules to give one or more filtering circuits.

According to one embodiment, the adapter frame has a partition which divides the space delimited by the frame into a filtrate chamber and a feed chamber, these two chambers being connected to the filtrate and feed connector elements on the pressure plate or end plate. The filtrate chamber is connected, via filtrate conduits disposed in the feed chamber, to the filtrate orifices in the perforated plate, or the feed chamber is connected, via feed conduits disposed in the filtrate chamber, to the filtrate orifices in the perforated plate.

According to another embodiment, the adapter frame has connecting means for feeding in feed and removing filtrate, and the filtrate connecting means are connected, via filtrate conduits, to the filtrate orifices in the perforated plate, or the feed connecting means are connected, via feed conduits, to the feed orifices in the perforated plate.

Preferably, the filtering device comprises filter modules equipped with filtering elements which are attached to each other and can be displaced, relatively to each other, along the longitudinal axis of the filter module so that when the pressing device is actuated, the filtering elements and the filter modules can be compressed such that the necessary seal both between the filter modules and between the filtering elements and the filter modules and the intermediate plates or adapters can be achieved.

To ensure that the filter module can be installed in the filter chamber with all its sides at the same distance therefrom, the filter module possesses projecting spacing elements around its perimeter. An alternative possibility is to provide these spacing elements in the filter chamber.

The invention also relates to filter carriages for filter presses, which are characterized in that they exhibit a compression-proof outer wall, which surrounds at least one chamber for the accommodation of a filter module composed of filtering elements, said filter carriages being open at one or both ends for the introduction of the filter modules and are provided with rolling or sliding means on said outside wall. These rolling or sliding means are preferably adapted to the design of the cross beams of existing filter presses so that retrofitting of existing filtering devices can be carried out in without any problems.

The length of the filter carriages is preferably between 10 cm and 1 m. The filter carriage preferably comprises a bundle of rectangular pressure tubes, which, for example, are welded to each other or braced together. Particular embodiments of the filter carriages have already been described in connection with the filtering device.

The retrofit kit (supplementary set) of the invention for a filtering device, in particular a filter press, having a pressure plate mounted on a support on which it can be moved by a pressing device, and having a stationary end plate connected to the pressure plate via said support, which pressure plate and/or end plate have connections for feed and filtrate, whilst space is provided between the pressure plate and the end plate for the accommodation of filtering elements, contains at least one such filter carriage. Exemplary embodiments of the invention are illustrated below with reference to the drawing.

### BRIEF DESCRIPTION OF THE DRAWINGS

FIG. 1 shows a filtering device according to the prior art;

FIG. 2 is a section through a device of the invention comprising a filter carriage;

FIG. 3a illustrates the filtering device shown in FIG. 2 in the opened state;

FIG. 3b is a perspective view of a filter carriage;

FIG. 3c is a perspective view of a filter module;

FIG. 4 shows a filtering device according to another embodiment;

FIG. 5 shows a filtering device according to another embodiment;

FIGS. 6, 7, 8a, 8b, 9a, 9b, 9c are plan views of the end faces of filter carriages according to various embodiments;

FIG. 10 is a plan view of a backing plate;

FIG. 11 a top view of an adapter frame;

FIG. 12 is a vertical cross section through an adapter with filter carriage and end plate taken along the line A-A in FIG. 13; and

FIG. 13 is a plan view of an adapter frame according to another embodiment.

### DETAILED DESCRIPTION OF THE INVENTION

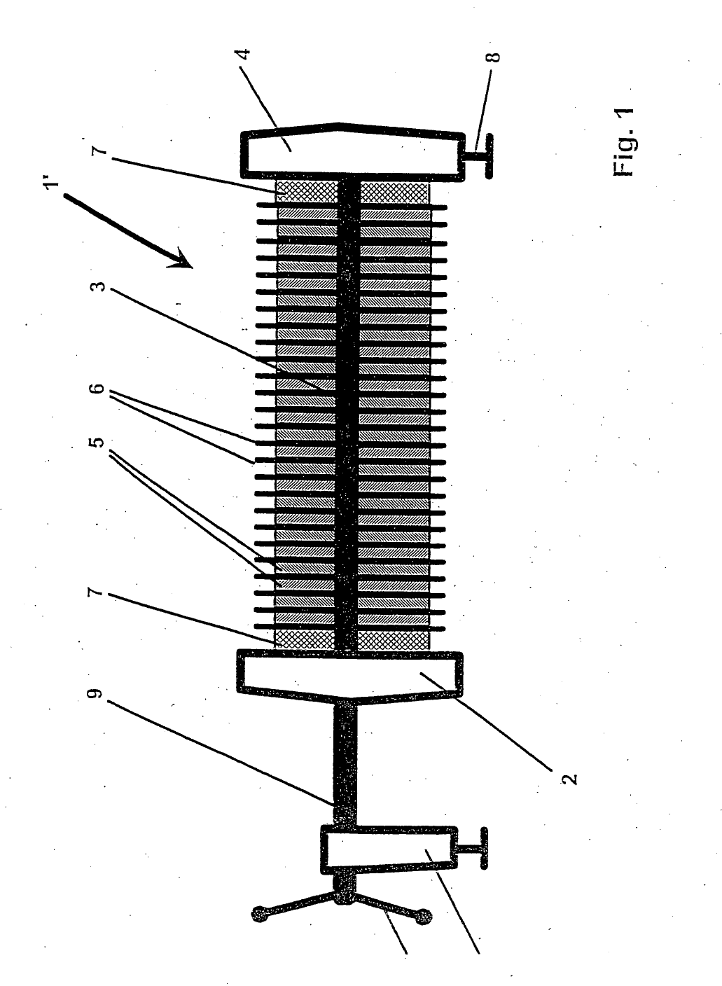

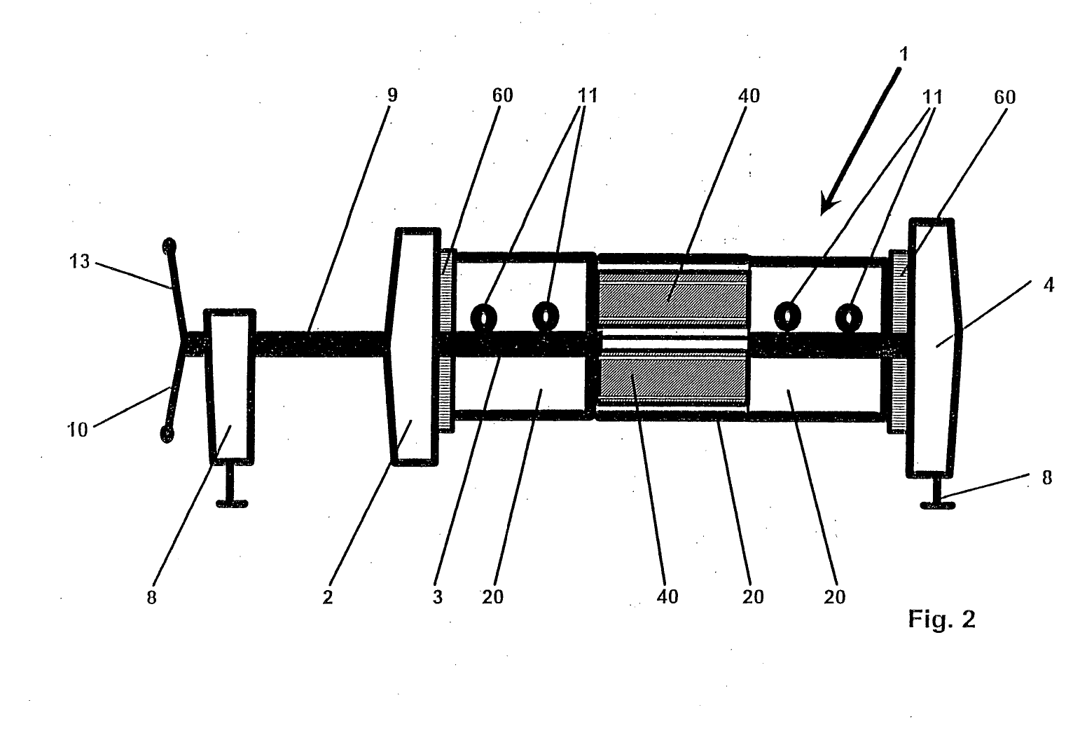

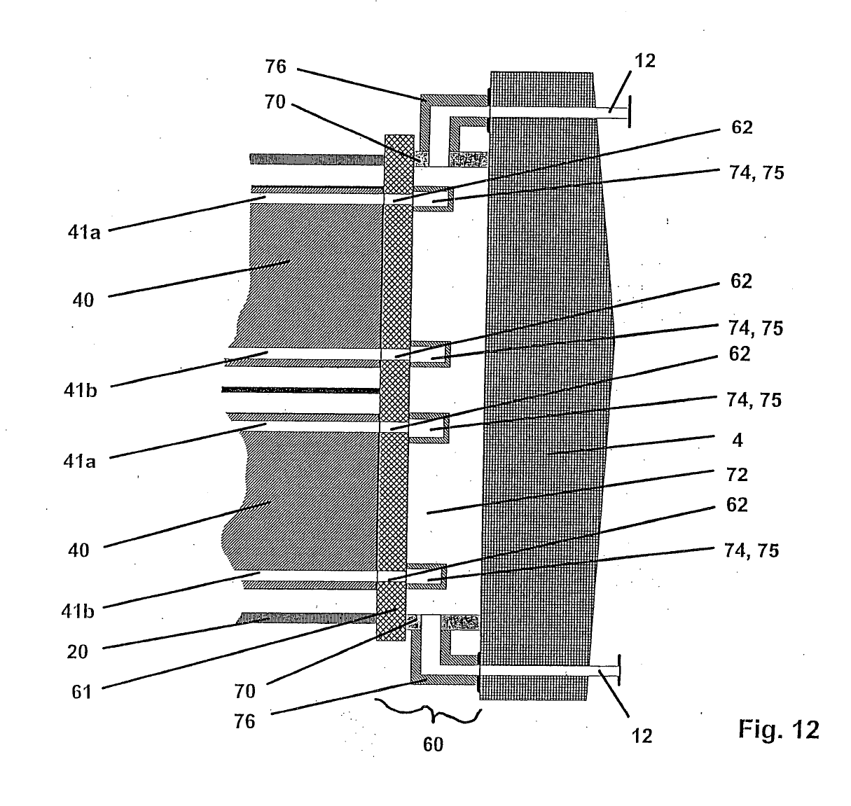

FIG. 2 illustrates a filtering device 1, which, as already explained in connection with FIG. 1, exhibits a rack having pillars 8, a pressure plate 2, an end plate 4, and a pressing device 10 comprising a handwheel and a spindle 9. Between the pressure plate 2 and the end plate 4 there are displaceably mounted three filter carriages 20 on the cross beams 3 forming part of a support. To this end, the filter carriages 20 possess external rollers 11. Between the filter carriage 20 and the pressure plate 2 or the end plate 4 there is disposed, in each case, an adapter 60, which is explained in greater detail in connection with FIGS. 12 to 15.

The middle carriage is shown as a cross-section so that the superposed filter modules 40 disposed in the interior of the filter carriage 20 can be seen.

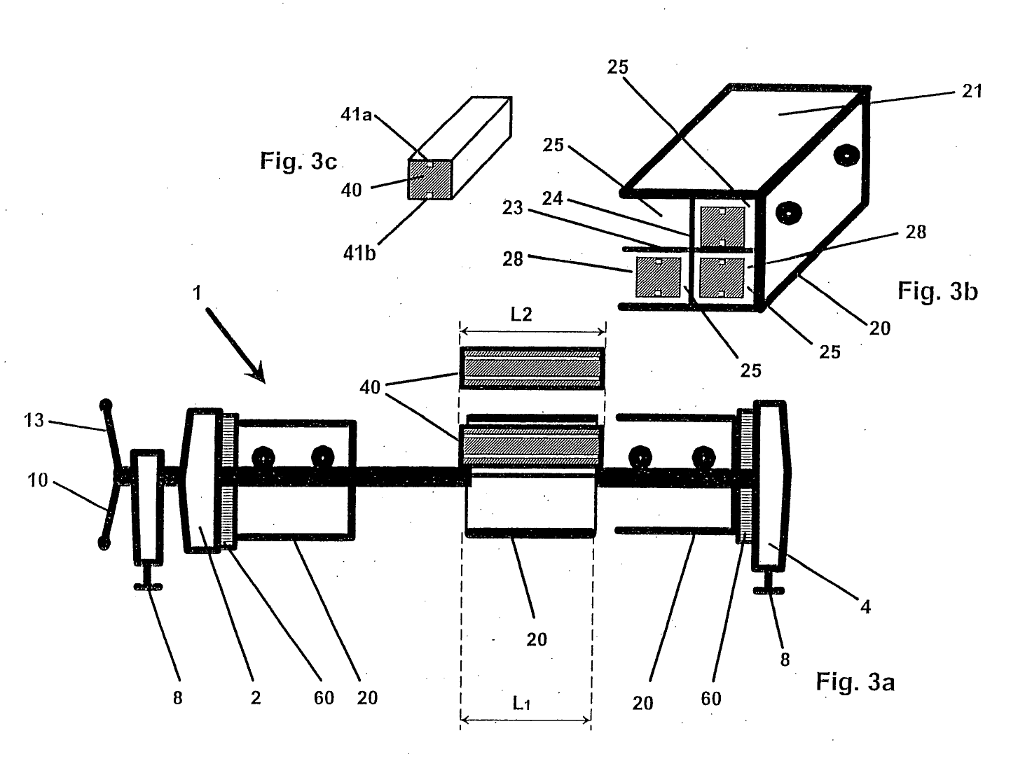

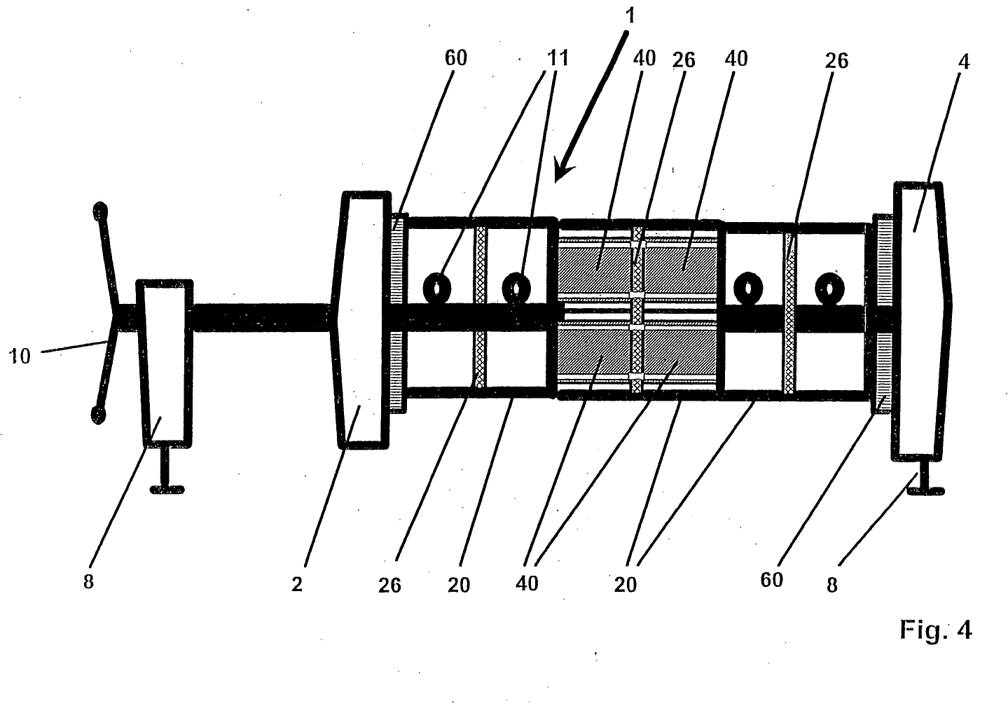

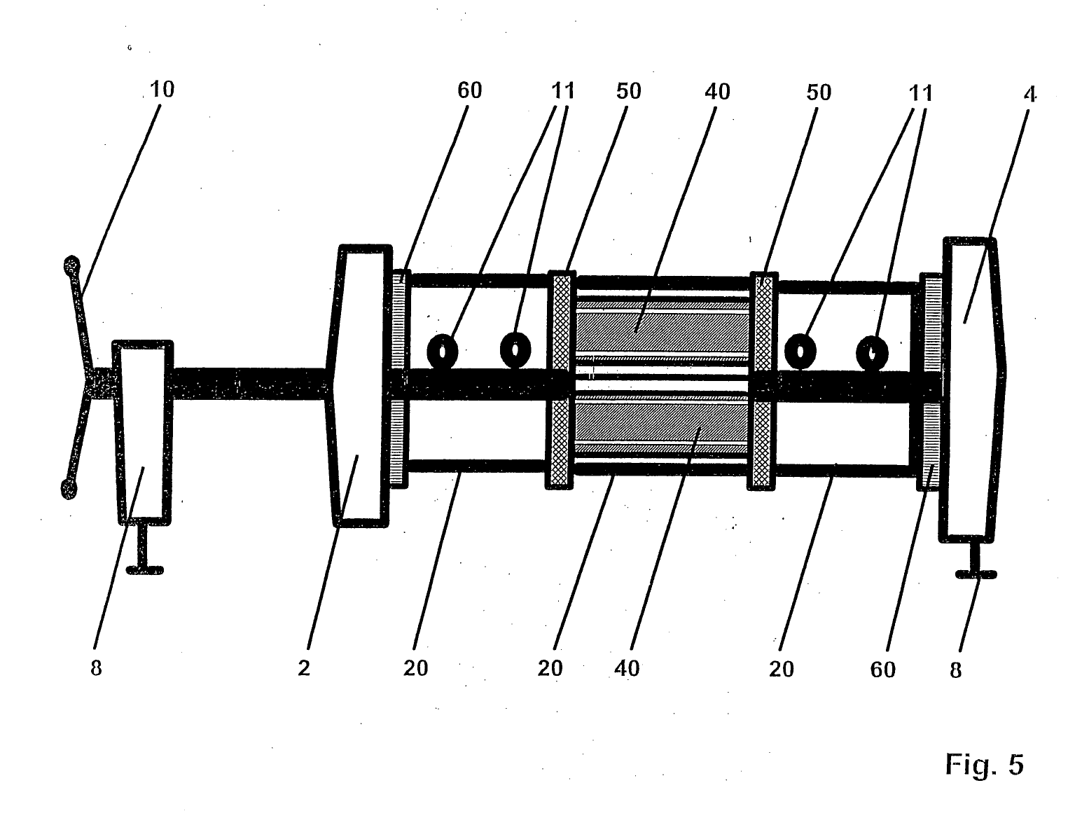

FIG. 3a shows the filtering device 1 in the opened state. The pressing device 10 has been opened by turning the handwheel 13 to cause the pressure plate 2 to be withdrawn and to afford accessibility to the interior of the filter carriages 20.

As shown in FIG. 3b, the filter carriages are rectangular in cross-section and enclose a total of four juxtaposed and superposed chambers 25. The outer wall 21 is compression-proof. For reinforcement, internal horizontal struts 23 and internal vertical struts 24 are provided, which together form a stiffening cross. These struts 23 and 24 are arranged in such a manner that they delimit the chambers 25. In each chamber there is a filter module 40, whose axial length L₁ is greater than the length of the filter carriage 20, designated by L₂. By reason of these different lengths, the filter module 40 projects beyond the end faces of the filter carriage so that when the filtering device 1 is closed by means of the pressing device 10, the filter modules 40 are pressed against each other.

As shown in FIG. 3c, each filter module possesses in its interior two filtrate interceptors 41a and 41b. The filter modules are placed in the filter chambers 25 such that the two filtrate interceptors 41a and 41b are superposed. The aim of this arrangement is to afford unproblematic deaeration of the filter module through the filtrate interceptor 41a when the filter module is filled. Filtrate interceptor 41b is provided to make it possible to empty the filter module completely after filtration. More than two filtrate interceptors may be present, if desired.

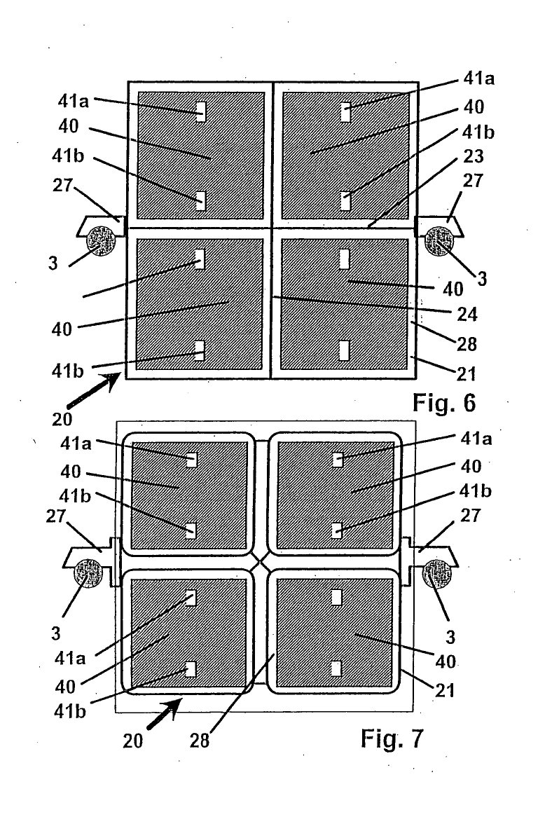

FIG. 4 illustrates another embodiment, in which filter carriages 20 are provided with a vertical partition 26. This means that a total of eight chambers, i.e., four+four chambers, are formed in each filter carriage 20, into which filter modules 40 can be inserted. The partition 26 has feed or non-filtrate orifices and filtrate orifices so that unhindered change of non-filtrate is possible and the filtrate interceptors of adjacent filter modules can communicate with each other.

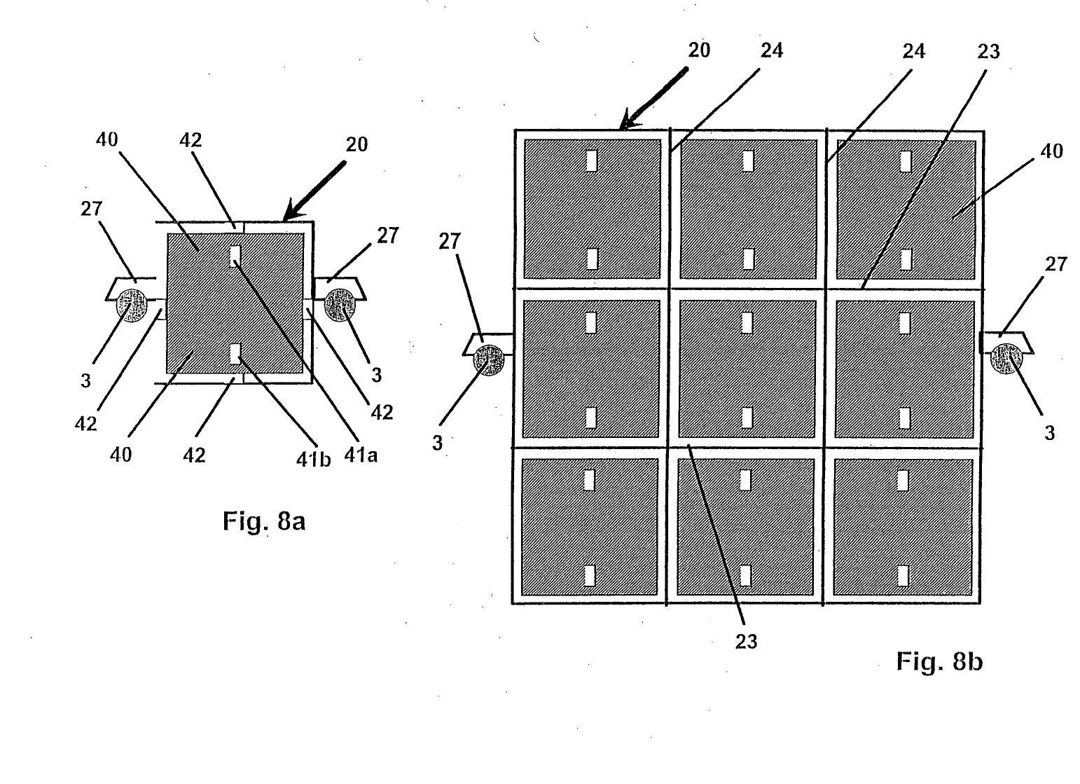

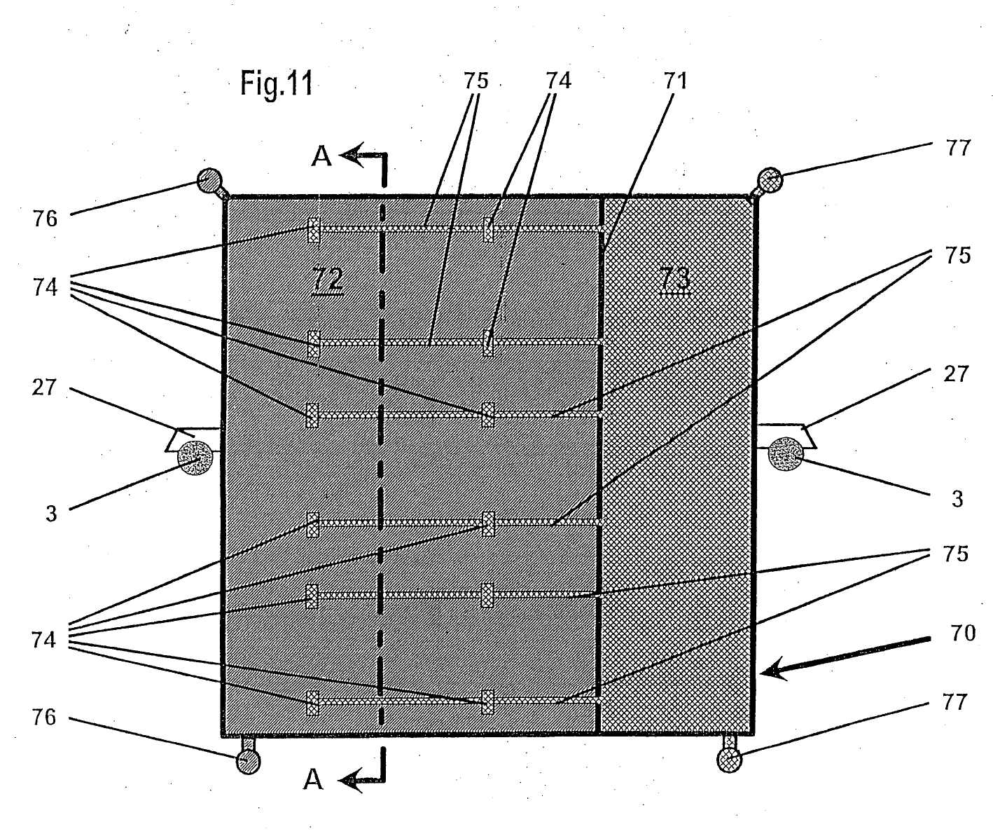

FIG. 5 illustrates another embodiment, in which intermediate plates 50 are disposed between the filter carriages 20. These intermediate plates 50 serve to stabilize the filter module configuration. Due to the fact that the filter modules 40 are not directly juxtaposed but each rests with its end face against the intermediate plate 50, sagging of the chain of filter modules is prevented. These intermediate plates are explained in greater detail in connection with FIG. 11.

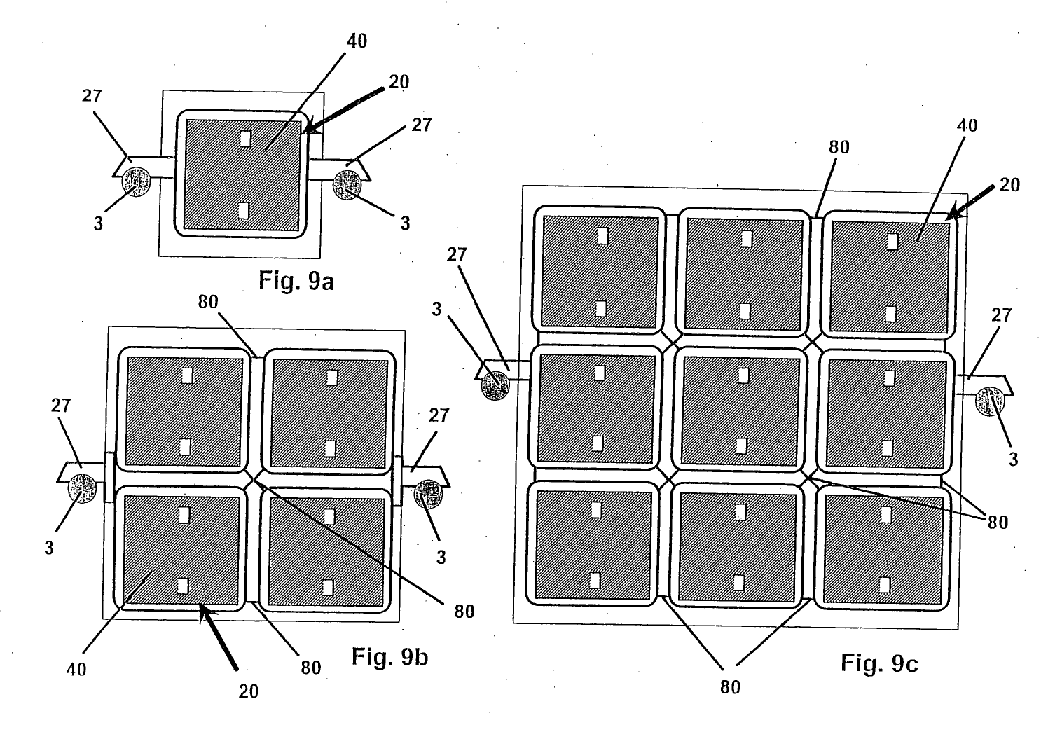

FIG. 6 shows a plan view of the end face of a filter carriage which is square in cross-section and has four filter modules 40 inserted therein. To the outer wall 21 of the filter carriage 20 there is fixed, on both sides, a bearing element 27, by means of which the filter carriage 20 rests on the two cross beams 3. The filter modules 40 in the quadratic filter chambers 25 are set at a distance from the outer wall 21 and the horizontal and vertical struts 23, 24 so that the feed chamber 28 is formed between the filter modules and the chamber delimiting means.

FIG. 7 is a plan view of the end face of a similarly square filter carriage 20 composed of rectangular tubes welded to each other.

FIGS. 8a and 8b show two further embodiments, FIG. 8a depicting the smallest variant having one chamber and one filter module 40. The filter module 40 illustrated in FIG. 8a is provided with spacing elements 42 around its perimeter to ensure that the filter module 40 can be set at a distance from the filter carriage 20 on all sides. FIG. 8b shows another embodiment having a total of nine filter chambers, these being formed by horizontal struts 23 and vertical struts 24. The filter carriages 20 according to FIGS. 8a and 8b and also 6 comply with specific modular dimensions so that a regular distribution of the filtrate chambers is possible, and filter modules of the same sectional area can be used.

In FIGS. 9a to 9c there are shown corresponding arrangements involving square tubes and corresponding chambers. The tubes are interconnected by braces 80. The square outline corresponds to the dimensions of the square filter carriage 20 according to FIGS. 6 and 8a, 8b. In this embodiment it is again possible to accommodate one, four, or nine chambers 20 by reason of their modular dimensions.

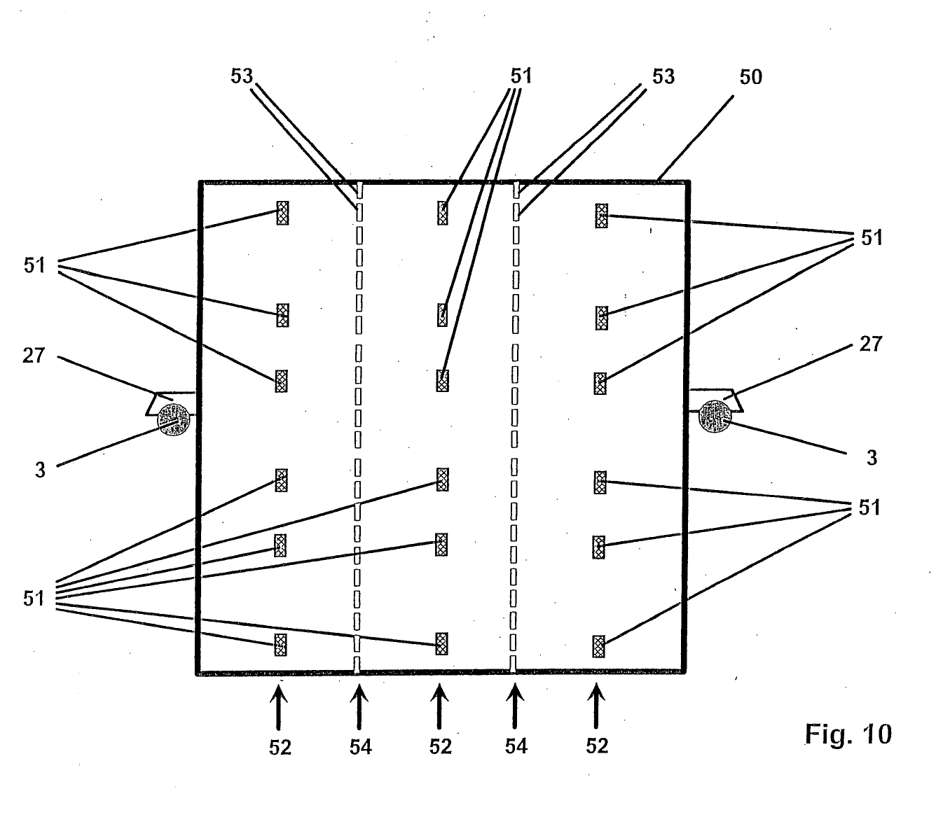

FIG. 10 is a plan view of an intermediate plate 50, which can be disposed between filter carriages according to FIG. 8b. The intermediate plate 50 is basically a perforated plate exhibiting rows 52 of filtrate orifices 51 and rows 54 of non-filtrate orifices 53. The filtrate orifices 51 are arranged in such a manner that they are opposite to the filtrate channels 41a, 41b. The feed orifices 53 are disposed between the rows 52 in such a manner that all filtrate chambers are supplied with feed as evenly as possible. In addition, two rows of feed orifices 53 are further provided at the outer edge in the vicinity of the outer wall 21.

The perforated plate 61 as a component of the adapter 60 corresponds to the intermediate plate 50 and can exhibit, in the four corner regions, feed orifices and filtrate orifices which cooperate with the corresponding orifices 76 and 77 in the adapter frame 70, as illustrated in FIG. 11. The adapter frame 70 possesses a vertical separating wall 71 so that the interior of the adapter frame is divided into a feed chamber 72 and a filtrate chamber 73. Since, by reason of the arrangement of the filter modules, the filtrate interceptors open into the region of the feed chamber 72, filtrate connections 74 and corresponding filtrate pipes 75 are provided in this region, which pipes extend in a horizontal direction and open into the filtrate chamber 73 at the separating wall 71.

FIG. 12 is a cross-section illustrating the cooperation between perforated plate 61 and adapter frame 70. The two filter modules 40 shown rest against the perforated plate 61 in such a manner that the filtrate interceptors 41a, 41b bear sealingly against the filtrate orifices 62. The opposite side of the perforated plate 61 is adjoined by filtrate connections 74 and filtrate pipes 75. The adapter frame 70 also possesses non-filtrate orifices 76, which supply non-filtrate chamber 72 via the non-filtrate inlets 12 in the end plate 4.

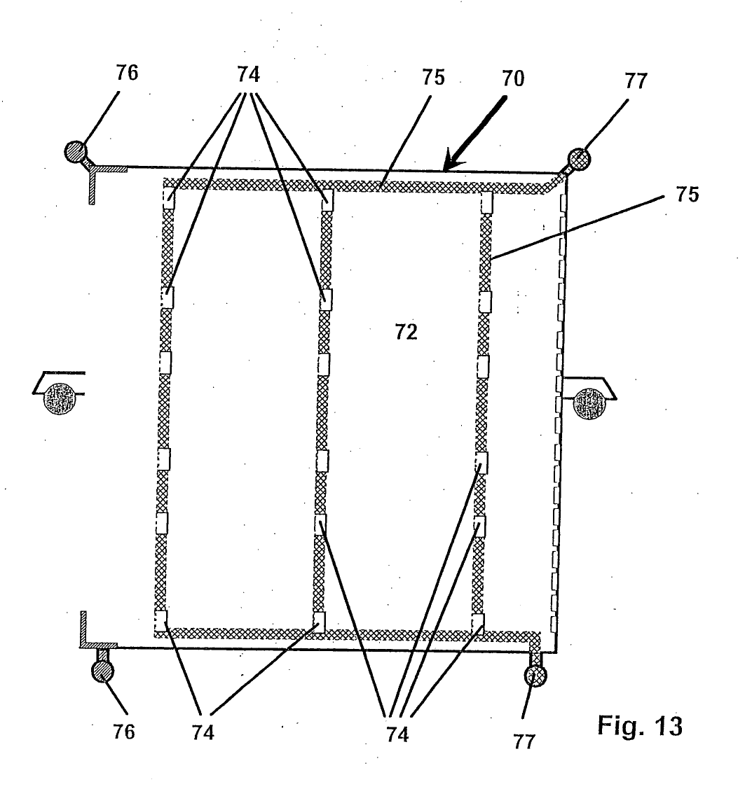

FIG. 13 shows another embodiment of the adapter frame 70. In the embodiment shown here there is only one feed chamber 72, in which a piping system comprising filtrate pipes 75 is disposed, which piping system is connected to the filtrate orifices 77 and interconnects all of the filtrate connections 74.

The terms “vertical” and “horizontal” refer to the horizontal filtering device described above by way of example. The filtering device can also be vertically oriented, in which case the rolling and sliding means of the filter carriage will have to be modified appropriately.

In the Figures the chamber 28 is designated as the feed chamber. Alternatively, the filter module can be operated inversely, i.e., employing a reversed direction of flow so that the chamber 28 will then form the filtrate chamber. Similar considerations apply to the orifices 41a, 41b.

1. A filter apparatus comprising
a support extending along a lengthwise direction of the filter apparatus,
a pressing device comprising a stationary head mounted at one end of said support and a movable head which is movably supported on said support and spaced apart from said stationary head,
at least one filter carriage including a pressure-resistant housing which defines a chamber,
said chamber accommodating one or more filter modules which are comprised of a plurality of filter elements,
said filter carriage being movably supported on said support in between said stationary and movable heads, and
said stationary and/or movable head comprising connector elements for feed and filtrate.

2. The apparatus of claim 1, wherein said support comprises at least two cross beams movably supporting said movable head and said carriage.

3. The apparatus according to claim 1, wherein the chamber and the support each have a longitudinal axis and the longitudinal axis of the chamber extends parallel to the longitudinal axis of the support.

4. The apparatus according to claim 1, wherein the filter carriage is open on one or both sides for insertion of the one or more filter modules.

5. The apparatus according to claim 1, wherein the filter carriage is rectangular in cross-section.

6. The apparatus according to claim 1, wherein the filter carriage has at least one horizontal and/or vertical tensile-loadable strut on the inside, the strut or struts being arranged to form a boundary of the chamber.

7. The apparatus according to claims 1, wherein the filter carriage has one, four, or nine chambers whose cross-sections correspond to predefined modular dimensions.

8. The apparatus according to claim 1, wherein the filter carriage has a longitudinal axis and has at least two chambers positioned one behind the other in the direction of its longitudinal axis, which are separated from each other by a vertical intermediate wall comprising filtrate and feed openings.

9. The apparatus according to claim 1, wherein the length L₁ of the chamber is smaller than L₂, wherein L₂ is the length of the filter module to be inserted in the chamber.

10. The apparatus according to claim 1, wherein in between two filter carriages an intermediate plate is arranged matching in cross-section the filter carriage and having filtrate and feed openings.

11. The apparatus according to claim 10, wherein the intermediate plate is movably supported on the support.

12. The apparatus according to claim 1, wherein between the movable head and an adjacent filter carriage and/or the stationary head and an adjacent filter carriage an adapter is arranged with means for supplying feed and removing filtrate.

13. The apparatus according to claim 12, wherein the adapter comprises a perforated plate adjacent to the filter carriage and an adapter frame arranged between the perforated plate and the stationary head or movable head.

14. The apparatus according to claim 13, wherein the perforated plate has filtrate and feed openings.

15. The apparatus according to claim 13, wherein the adapter frame connects the connector elements for filtrate and feed provided in the movable head and/or in the stationary head with the filter module or the filter modules to form one or a plurality of filter circuits.

16. The apparatus according to claim 13, wherein the adapter frame has a separating wall which divides an inner space limited by the frame into a filtrate chamber and a feed chamber, wherein the two chambers are connected to the filtrate and feed connector elements of the movable and/or stationary head and wherein the filtrate chamber is connected via filtrate pipes arranged in the feed chamber to the filtrate openings in the perforated plate or wherein the feed chamber is connected via feed pipes arranged in the filtrate chamber to the feed openings in the perforated plate.

17. The apparatus according to claim 13, wherein the adapter frame has connector means for the supply of feed and the removal of filtrate, wherein the filtrate connector means are connected via filtrate pipes to the filtrate opening in the perforated plate or the feed connecting means are connected via feed pipes to the feed opening in the perforated plate.

18. The apparatus with a filter module inserted in the chamber of the filter carriage according to claim 1, wherein the filter elements of the filter module are movably interconnected with one another in the direction of the longitudinal axis of the filter module.

19. The apparatus according to claim 17, wherein the filter module has spacer elements projecting at its outer circumference.

20. A filter carriage for filter presses comprising a compression-proof outer wall which defines at least one chamber to accommodate at least one filter module comprised of a plurality of filter elements,
being open at one or both ends for insertion of the filter module and having roller or sliding devices arranged on the outer wall.

21. The filter carriage according to claim 20, having a rectangular cross-section.

22. The filter carriage according to 20, having at least one horizontal and/or vertical tensile strut in its interior said strut(s) being disposed to delimit the chamber.

23. The filter carriage according to claim 20, having a longitudinal axis and at least two chambers positioned one behind the other in the direction of its longitudinal axis, and which are separated from one another by a vertical intermediate wall comprising filtrate and feed openings.

24. The filter carriage according to 20, comprising a bundle of pressure tubes.

25. A supplementary set for a filter apparatus having
a support extending along a lengthwise direction of the filter apparatus,
a pressing device comprising a stationary head mounted at one end of said support and a movable head which is movably supported on said support and spaced apart from said stationary head, said stationary and/or movable head comprising connector elements for feed and filtrate,
said supplementary set comprising at least one filter carriage and a first and a second adapter plate,
said carriage including a pressure-resistant housing which defines a chamber and being adapted to be movably supported on said support in between said stationary and movable heads,
said chamber accommodating one or more filter modules which are comprised of a plurality of filter elements, and
said adapter plates comprising openings for feed and filtrate to provide a fluid connection between corresponding feed and filtrate outlets of the at least one filter module accommodated in the chamber of the carriage and the feed and filtrate connectors of the movable and stationary heads of the pressing device.
